(19) United States
(12) Patent Application Publication
(10) Pub. No.: US 2010/0115673 A1
(43) Pub. Date: May 6, 2010

(54) NEAR FIELD SCANNING MEASUREMENT-ALTERNATING CURRENT-SCANNING ELECTROCHEMICAL MICROSCOPY DEVICES AND MEHTODS OF USE THEREOF

(76) Inventors: Christine Kranz, Atlanta, GA (US); Boris Mizaikoff, Atlanta, CA (US); Wolfgang Schuhmann, Bochum (DE); Kathrin Eckhard, Bonn (DE)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/312,705

(22) PCT Filed: Nov. 27, 2007
(86) PCT No.: PCT/US2007/024378

§ 371 Date: Jan. 13, 2010

Related U.S. Application Data
(60) Provisional application No. 60/867,331, filed on Nov. 27, 2006.

(51) Int. Cl. G01Q 60/18; G01Q 60/32

(52) U.S. Cl. 850/30; 850/37

(57) ABSTRACT

Briefly described, embodiments of this disclosure include near-field scanning measurement-alternating current-scanning electrochemical microscopy devices, near-field scanning measurement-alternating current-scanning electrochemical microscopy systems, methods of using near-field scanning measurement-alternating current-scanning electrochemical microscopy, atomic force measurement-alternating current-scanning electrochemical microscopy (AFM-AC-SECM) devices, AFM-AC-SECM systems, methods of using AFM-AC-SECM, and the like.

### CROSS-REFERENCE TO RELATED APPLICATION

This application is related to copending U.S. Provisional Application entitled “Alternating Current Imaging with Bifunctional Atomic Force Scanning Electrochemical Microscopy Tips” Ser. No. 60/867,331, filed on Nov. 27, 2006, which is entirely incorporated herein by reference.

### FEDERAL SPONSORSHIP

This invention was made with Government support under Contract/Grant No. 0216368 and 0343028, awarded by the National Science Foundation. The Government has certain rights in this invention.

### BACKGROUND

Electrochemical impedance spectroscopy (EIS) is a well-established technique for macroscopically characterizing charge transport at various systems ranging from bulk materials to solid/liquid interfaces. The impedance is obtained as a function of the frequency by applying an AC voltage with small amplitude resulting in a response different in amplitude and phase from the perturbation. Usually, EIS measurements are conducted at a macroscopic scale. However, corrosion related processes, and especially the initial stages of corrosion, are dominated by events occurring at the microscopic/nanoscopic level. Researchers have described localized electrochemical impedance spectroscopy (LEIS) at a microscale with a five-electrode assembly including a probe comprising a pair of Pt-microelectrodes, which were additionally modified with a Pt-black layer for minimizing interfacial impedance. Other researchers used the same type of instrumentation for mapping of localized impedance data at a constant frequency.

In scanning electrochemical microscopy (SECM), alternating current has been originally used to control the z-position of the probe. The AC signal is distance dependent as well as sensitive to the electrochemical nature of the substrate. On electronically homogeneous samples it can, thus, be utilized in a feedback loop to perform spatially resolved electrochemical measurements in constant tip-to-sample distance. Alternatively, the distribution of electrochemical properties on a surface can be investigated using AC-SECM with high lateral resolution. The main advantage of this approach is the fact that it is obsolete to add to the solution any redox mediator, which may have an adverse impact on the investigated surface processes. Furthermore, AC-SECM imaging has been conducted in a current independent constant-distance mode, where the recording probe simultaneously follows the topography utilizing the SECM shear force mode. Although sub-microelectrodes are now more commonly used in SECM experiments, the lateral resolution of the topography images currently achievable in SECM cannot compete with AFM or STM due to the underlying physical measurement principle and the probe geometry/dimensions in SECM, which is governed by diffusion processes, in contrast to force interactions between a sharp tip and the sample surface in AFM.

High-resolution impedance spectroscopy using a conductive AFM tip has been introduced as nanoimpedance microscopy (NIM). In general, scanning probe microscopy techniques, and especially AFM, have matured to routine surface analytical tools providing high-resolution information on surface properties of the sample in dependence of the nature of the probe, and the probe-sample interaction principle. NIM measurements were conducted in air using contact mode imaging with a conductive AFM tip (cAFM) providing localized frequency dependent properties at the probe/sample interface. Since the apex of the tip is in direct contact with the sample surface, measurements are usually performed at fixed frequencies, and may provide ambiguous results due to mechanical wear at the probe, or contamination of the electrode layer. Hence, AFM-SECM measurements with the conductive layer extending to the apex of the tip are usually obtained in a sequential mode (‘lift mode’). Alternatively, the design of integrated AFM-SECM tips comprises an electrode recessed from the apex of an insulating silicon nitride tip, which enables simultaneous mapping of electrochemistry and topography with high resolution, and without deterioration of the electrode surface even if the tip is operated in contact mode AFM (See, U.S. Pat. No. 6,894,272).

### SUMMARY

Briefly described, embodiments of this disclosure include near-field scanning measurement-alternating current-scanning electrochemical microscopy devices, near-field scanning measurement-alternating current-scanning electrochemical microscopy systems, methods of using near-field scanning measurement-alternating current-scanning electrochemical microscopy, atomic force measurement-alternating current-scanning electrochemical microscopy (AFM-AC-SECM) devices, AFM-AC-SECM systems, methods of using AFM-AC-SECM, and the like.

One exemplary near-field scanning measurement-alternating current-scanning electrochemical microscopy device, among others, includes: a region for topographical near field measurement; and a region for electrochemical near field measurement, wherein the region for the electrochemical near field measurement is in electrical communication with an alternating current (AC) supply system such that the region for the electrochemical near field measurement is configured to receive an AC potential from the AC supply system.

One exemplary atomic force measurement-alternating current-scanning electrochemical microscopy system, among others, includes: a device including: a region for topographical near field measurement; and a region for electrochemical near field measurement, wherein the region for the electrochemical near field measurement is in electrical communication with an alternating current (AC) supply system such that the region for the electrochemical near field measurement is configured to receive an AC potential from the AC supply system, and a measurement cell including the device and an artificially added electroactive species free solution.

One exemplary method for examination of a surface of a substrate, among others, includes: providing an atomic force measurement-alternating current-scanning electrochemical microscopy system, comprising: a device including: a region adapted for topographical near field measurement; and a region for electrochemical near field measurement, wherein the region for the electrochemical near field measurement is in electrical communication with an alternating current (AC) supply system such that the region for the electrochemical near field measurement is configured to receive an AC potential from the AC supply system, and a measurement cell including the device and an artificially added electroactive species free solution; disposing the device adjacent the surface, wherein the surface is to be examined by the region adapted for topographical near field measurement and the region for electrochemical near field measurement, wherein the region adapted for topographical near field measurement measures a distance to the surface, and wherein the region for electrochemical near field measurement measures frequency-dependent impedance change in the artificially added electroactive species free solution; and examining the surface by moving the device over the surface.

Other systems, methods, features, and advantages of this disclosure will be or become apparent to one with skill in the art upon examination of the following drawings and detailed description. It is intended that all such additional systems, methods, features, and advantages be included within this description, be within the scope of this disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings.

The patent or application file contains at least one drawing executed in color. Copies of this patent or patent application publication with color drawing(s) will be provided by the Office upon request and payment of the necessary fee.

FIG. 1 is a block diagram of an AFM-AC-SECM system.

FIG. 2A is a cross section diagram of a portion of the AFM-AC-SECM device.

FIG. 2B is a top view of the AFM-AC-SECM device illustrated in FIG. 2A.

FIG. 3 (left top and bottom) illustrates a signal generation process in conventional SECM experiment with a redox mediator in solution reduced at the AFM tip-integrated working electrode, thereby generating a Faradaic redox current measured in a three-electrode configuration using a reference electrode (CE) and an auxiliary electrode (Aux).

FIG. 3 (right top and bottom) illustrates an embodiment of the present disclosure for a signal generation process in an AFM-AC-SECM experiment without a redox mediator in solution measuring frequency-dependent impedance changes of an AC current generated by the superposition of a sinusoidal AC voltage onto the DC potential applied to the AFM tip-integrated working electrode.

FIG. 4 illustrates an equivalent electronic circuit for AC measurements.

FIG. 5 illustrates an AC potential (gray) and resulting AC current response (green).

FIG. 6 illustrates an SEM image of an integrated IBID electrode along with the obtained cyclic voltammograms.

FIG. 7 illustrates a scheme of the experimental set-up: (a) lock-in amplifier, (b) potentiostat, (c) AFM positioning laser, (d) mirror, (e) split photo diode, (f) topographical information, (g) feedback controller, (h) x, y, z positioning unit, (i) topographic image, (j) electrochemical image.

FIG. 8 illustrates a normalized current R(R_{d}/R_{∞}) values as a function of tip-to-sample separation. L represents Z-distance normalized by the active electrode diameter. Electrode diameter: 7 μm; frequency: 1 kHz; amplitude:=100 mVₚₚ; solution:=1 mM KCl.

FIG. 9 simultaneously recorded AFM topography and AC-SECM measurement with AFM tip-integrated ring microelectrode at a structured glass/gold substrate: (FIG. 9A) topography recorded in contact mode; scanned area: 8.5×25 μm; scan speed: 0.15 lines/sec, (FIG. 9B) simultaneously recorded AC-SECM image at 5.01 kHz and 110 mVₚₚ superimposed onto a −100 mV DC bias applied to the tip-integrated WE in 1 mM KCl.

FIG. 10 illustrates images of periodically microstructured silicon nitride/gold structure with recessed 1 μm gold spots: (FIG. 10A) topography recorded in contact mode; scanned area: 25×25 μm; scan speed: 0.1 lines/sec, (FIG. 10B) simultaneously recorded AC-SECM image at 14.92 kHz and 110 mVₚₚ superimposed onto a −100 mV DC bias applied to the tip-integrated WE in 1 mM KCl.

FIG. 11 illustrates an AC-SECM approach curves on SiO₂ (FIG. 11A) and Au (FIG. 11B). Displayed is the current magnitude vs. z-distance. 10 μm tip, 1 mM KClO₄, Vₚₚ=100 mV, f=1.6 kHz, 8 kHz, and 47 kHz.

FIG. 12 illustrates the simultaneously recorded contact mode AFM (left) and AC-SECM image (right), scan area 25 μm×25 μm, c=1 mM KCl, Vₚₚ110 mV, f=5.01 kHz.

FIG. 13A illustrates a schematic close-up on the integrated tip electrode and the sample. Distances are to scale. FIG. 13B illustrates a schematic representation of AC-SECM approach curves towards an insulating surface (gray), towards a conductor at low perturbation frequency (dark yellow), and towards a conductor at high perturbation frequency (bright yellow). The inset shows the signal change upon variations in the sample conductivity along with the probe to sample distance. i) and ii) refer to the conditions shown in FIG. 13A.

FIG. 14 illustrates a series of AFM-AC-SECM measurements at different perturbation frequencies. Corresponding topographic information (left), electrochemical information (right). c=1 mM KCl, Vₚₚ=110 mV. Perturbation frequency is as indicated.

### DETAILED DESCRIPTION

Embodiments of the present disclosure will employ, unless otherwise indicated, techniques of physics, material science, chemistry, biochemistry, biology, and the like, which are within the skill of the art. Such techniques are explained fully in the literature and will not be detailed herein.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, surface coatings, manufacturing processes, dimensions, frequency ranges, applications, or the like, as such can vary. It is also to be understood that the terminology used herein is for purposes of describing particular embodiments only, and is not intended to be limiting. It is also possible in the present disclosure that steps can be executed in different sequence, where this is logically possible. It is also possible that the embodiments of the present disclosure can be applied to additional embodiments involving measurements beyond the examples described herein, which are not intended to be limiting. It is furthermore possible that the embodiments of the present disclosure can be combined or integrated with other measurement techniques beyond the examples described herein, which are not intended to be limiting.

It should be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Discussion

Embodiments of the present disclosure include near field scanning measurement-alternating current-scanning electrochemical microscopy devices, near field scanning measurement-alternating current-scanning electrochemical microscopy systems, methods of using near field scanning measurement-alternating current-scanning electrochemical microscopy, atomic force measurement-alternating current-scanning electrochemical microscopy (AFM-AC-SECM) devices, AFM-AC-SECM systems, methods of using AFM-AC-SECM, and the like.

Embodiments of the present disclosure can include near-field scanning probes such as, but not limited to, an atomic force microscope (AFM), scanning tunneling microscope (STM), scanning electrochemical microscope (SECM), scanning thermal microscope (SThM), and scanning Kelvin probe microscope, or other near-field microscopic techniques. Embodiments of the present disclosure are described in reference to AFM, but embodiments of the present disclosure can be extended to in include other near-field scanning techniques.

Embodiments of the present disclosure can be used to examine a surface of a substrate using an AFM-AC-SECM device including a region for topographical near field measurement and the region for electrochemical near field measurement without an electroactive species added to the solution. In particular, the region for topographical near field measurement is adapted to measure a distance to the surface of the substrate from a tip of the AFM-AC-SECM to obtain topographical information about the surface of the substrate. The region for electrochemical near field measurement is adapted to measure a frequency-dependent impedance change of an alternating current (AC) applied to the region for electrochemical near field measurement in solution without an electroactive species (e.g., a redox-mediator).

The phrases “without an electroactive species”, “without an electroactive species added to the solution”, “an artificially added electroactive species free solution”, “redox-mediator-free solution”, and the like mean that besides the molecular species already present at the investigated sample surface due to the observed processes, reactions, and/or molecular events (e.g., corrosion processes that may generate electroactive species, etc.), no additional constituents (e.g., a redox-mediator such as, but not limited to, ferrocyanide, ferrocenium methanol, rutheniumheaxammine chloride, iridiumhexachloride, etc.) need to be or are added to the device or system for obtaining an analytical signal or contrast during imaging. These terms may be used interchangeably in this disclosure.

In other words, an electroactive species is not added to the solution, but an electroactive species could be generated by a corrosion process, for example. In an embodiment, the electroactive species generated by a corrosion process is not necessary for using embodiments of the present disclosure and not necessary for measuring a signal using embodiments of the present disclosure.

In an embodiment, the concentration of the electroactive species generated by the corrosion process is not likely to have any impact or very little impact on the use of embodiments of the present disclosure and would not be enough for another device to generate a signal. In particular, an electroactive species (above that generated by the corrosion process) must be added to the solution for another device to operate unlike embodiments of the present disclosure.

In an embodiment, measurements using embodiments of the present disclosure do not influence or alter the chemistry of the surface by adding an electroactive species to the solution, so that a true measurement of the surface chemistry can be obtained unlike another device that must have an electroactive species added to the solution to operate (thus influencing or altering the surface chemistry).

The measurements performed by the region for topographical near field measurement and the region for electrochemical near field measurement are conducted simultaneously and independently of one another in the redox-mediator-free solution. At least one advantage of embodiments of the present disclosure relative to other techniques is that embodiments of the present disclosure do not include addition of an artificial redox mediator to the solution, where the redox-mediator could bias the electrochemical measurements since the redox-mediator reacts with the surface of the substrate (e.g., in corrosion studies), or otherwise alters the chemistry of the surface. In addition, since the topography is determined independently and absolutely, the convolution of electrochemical and topological information is avoided. Furthermore, the electrochemical localization can be improved using submicroelectrodes and nanoelectrodes with additional electrode material (such as e.g., via deposition of additional Pt and the like) providing for a high surface area, which has not been shown for AC measurements with other scanning probe microscopic techniques to date. Finally, the obtained AFM data using bifunctional tips are recorded with similar or higher resolution compared to commercially available AFM tips, however, provide supplemental electrochemical information. Additional details regarding this and other advantages are described below and in the Examples.

Embodiments of the present disclosure can be used to examine, detect, analyze, the surface of a substrate. In particular, embodiments of the present disclosure can scan (i.e., moving in x-, y-, or z-direction) the surface of a substrate to examine the topology and electrochemical characteristics of the surface of the substrate simultaneously and independently. In other words, embodiments of the present disclosure provide devices, systems, and methods for simultaneously and independently carrying out an electrochemical microscopy and a topographical near field microscopy in solution that does not need an additional electroactive species in the solution.

In particular, embodiments of the present disclosure can be used in examining corrosion. A pending goal in corrosion science is developing fundamental and molecular level understanding of processes occurring at surfaces and interfaces. For example, delamination at polymer/metal interfaces and corrosion of polymer/metal composites is a fundamental materials problem of substantial technological importance: organic coatings on steel, aluminum, or magnesium based alloys play a crucial role in automotive industries, aerospace, building, and appliance industries. For example, in encapsulated microelectronic devices (e.g., for mobile communication) the interface of the mould compound with a variety of metals such as e.g., Cu, Al, or Au is of critical importance for the long-term stability and sustained device performance. Degradation of the metal/polymer interface is mainly caused by (i) mechanical stress, (ii) chemical degradation at the interface, or (iii) electrochemically induced delamination initiated at defects. The latter is considered the most severe mechanism, as the delamination process may occur extremely fast, and frequently precedes other degradation reactions. Embodiments of the present disclosure can detect small defects in materials and coatings. Thus, corrosion measurements benefit from identifying corroding surfaces, or even potential corrosion sites at a micro- to nanometer scale. In particular, embodiments of the present disclosure can be used in applications such as, but not limited to, corrosion studies, degradation studies at thin polymer films, determination of related surface properties, resistance measurements at membranes and pores at synthetic or biological samples, and general impedance studies at yet unachieved lateral resolution.

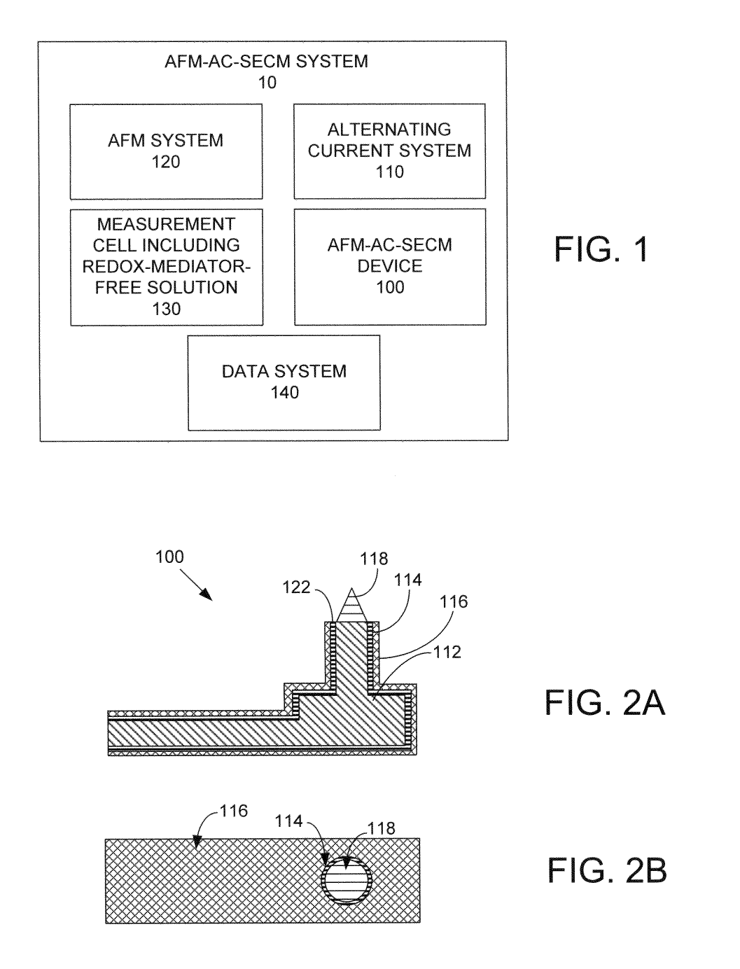

FIG. 1 is a block diagram of a AFM-AC-SECM system 10 that includes a AFM-AC-SECM device 100, an alternating current system 110, an AFM system 120, a measurement cell 130, and a data system 140. In addition, the AFM-AC-SECM system 10 can include other components and electronics to operate and perform in a manner as described herein. Additional details pertaining to the AFM-SECM are described in U.S. Pat. No. 6,894,272, which is incorporated herein by reference.

The AFM-AC-SECM device 100 is described in detail in reference to FIGS. 2A and 2B and Examples 1 and 2. FIG. 2A illustrates a cross-section of a portion of an embodiment of the AFM-AC-SECM device 100. Although not illustrated, the AFM-AC-SECM device 100 can include one or more electrical connections such as an electrical connection with the alternating current system 110. In addition, the AFM-AC-SECM device 100 can be in communication with the AFM system 120 so that measurements of the height (or distance from the surface of the substrate) can be conducted (e.g., via a laser system). Furthermore, the AFM system 120 can adjust the height of the AFM-AC-SECM device 100. Additional details regarding the AFM system 120 and AFM systems in general are described below and in Examples 1 and 2.

As shown in FIGS. 2A and 2B, the AFM-AC-SECM device 100 includes an AFM cantilever structure 112, a conducting layer 114, an insulating layer 116, and an AFM tip 118 (also referred to as immediate tip or tip). The exposed portion of the conducting layer 114 is the region of electrochemical near field measurement 122 (e.g., an ultramicroelectrode). The region of electrochemical near field measurement 122 is a defined distance from the AFM tip 118. The defined distance can be about 1 mm to 5 μm, about 5 μm to 500 nm, and about 500 nm to 5 nm. The region of electrochemical near field measurement 122 can be circular, frame-shaped, disk-shaped, polygonal, strips, and the like. Furthermore, multiple electrodes of any of these shapes or combinations thereof may be integrated into a single cantilever, or cantilever arrays.

The region for topographical near field measurement can be an area (e.g., a metallic or reflective surface) on the side opposite the AFM tip 118 where a laser beam contacts the AFM-AC-SECM device 100 and is reflected from the AFM-AC-SECM device 100. As the AFM-AC-SECM device 100 moves up and down with the contours of the surface of the substrate, the relative position of the laser beam will be modified. Thus, the contours of the surface can be examined and detected. In response to the change in the height (or relative distance from the surface of the substrate), the cantilever structure 112 of the AFM-AC-SECM device 100 can be deflected using the AFM system 120 to keep the height above the surface of the substrate constant or substantially constant.

For the purposes of the present disclosure, as the “region for topographical near field measurement”, or “region for electrochemical near field measurement”, respectively, that part or region of the device is to be understood at which the respective interaction with the surface to be examined occurs, i.e., the effect to be measured is causally taken up into the measurement device as a signal. For the topographical near field measurement, as a rule this will be the immediate tip. The “region for electrochemical near field measurement” as a rule will be on the outer side of the electrochemical near field measurement device that faces the sample surface (e.g., on a metallic layer).

The AFM tip 118 tapers from the base to the apex to form a tip. The AFM tip 118 can have diameter of about 500 μm to 5 μm, about 5 μm to 500 nm, and about 500 nm to 5 nm. The term “immediate tip” or “AFM tip” means a part of the probe or device tip that is located at the outermost end of this tip (e.g., may be only a few atoms in size). Hence follows that according to embodiments of the present disclosure the region for electrochemical near field measurement, as a rule, will lie on the tip portion of, e.g., a cantilever structure, yet not on the immediate tip on which the topographical near field measurement is carried out. If the near field interaction for topographic imaging is based on a contact-free scanning near field technique, the region for electrochemical near field measurement may however, as an exception, extend as far as to the tip.

The region of electrochemical near field measurement 122 can be made of materials such as, but not limited to, gold, platinum, carbon, copper, palladium, iridium, antimony, (doped) diamond, (doped) diamond-like carbon, and composites of each, and composites of each with other materials. In an embodiment, the inner diameter of the region of electrochemical near field measurement 122 is about 50 μm to 5 μm, about 5 μm to 500 nm, and about 500 nm to 5 nm. In an embodiment, the outer diameter of the region of electrochemical near field measurement 122 extends beyond the inner diameter by the thickness of the deposited electrode layer. The electrode layer has a thickness of about 50 μm to 5 μm, about 5 μm to 500 nm, and about 500 nm to 5 nm. In case of a disk-shaped electrode, the disk electrode diameter may range from about 50 μm to 5 μm, about 5 μm to 500 nm, and about 500 nm to 5 nm.

The other dimensions of the AFM-AC-SECM device 100 are similar to those of other AFM structures. In particular, details regarding these dimensions are described in U.S. Pat. No. 6,894,272.

The cantilever structure 112 is flexible and can be deflected to adjust the distance of the AFM-AC-SECM device 100 from the surface of the substrate. The cantilever structure 112 can be deflected and the deflection detected using the AFM system 120. The cantilever structure 112 is made of a material such as, but not limited to, silicon nitride, silicon, silicon dioxide, silicon carbide, polymers, and plastics. In particular, details regarding the cantilever structure 112 are described in U.S. Pat. No. 6,894,272.

The conducting layer 114 is made of a material such as, but not limited to, gold, platinum, carbon, copper, palladium, iridium, antimony, (doped) diamond, (doped) diamond-like carbon, composites of each, and composites of each with other materials.

The insulating layer 116 is made of a material such as, but not limited to, silicon nitride, silicon, silicon dioxide, silicon carbide, polymers, and plastics. The thickness of the insulating layer 116 can be about 50 μm to 5 μm, about 5 μm to 500 nm, and about 500 nm to 5 nm.

The AFM-AC-SECM device 100 is disposed adjacent a surface of a sample in the measurement cell 130. The measurement cell 130 includes a redox-mediator free solution such as an electrolyte solution having a concentration of salt (e.g., about 1 M to 0.0001 M). The electrolyte solution can be selected from solutions such as, but not limited to, KCl, NaCl, KNO₃, and K₂SO₄.

The alternating current (AC) system 110 functions to apply an AC potential to the region for the electrochemical near field measurement (e.g., ultramicroelectrode) of the AFM-AC-SECM device 100. In particular, the AC potential is a sinusoidal AC potential that is superimposed onto a DC potential applied between a reference electrode and the region for the electrochemical near field measurement. The AC system 110 includes a lock-in oscillator interfaced to a potentiostat, where the potentiostat is in electrical communication with the region for the electrochemical near field measurement. Additional details regarding the AC system 110 are described in Examples 1 and 2.

The AFM system 120 functions to measure the topography and surface properties of the surface of the substrate. The measurement is conducted with a resolution in the molecular to atomic range by surface forces between an AFM tip 118 by deflection of the cantilever structure 112. General illustrations of various techniques applicable within the scope of the present disclosure for topographical and electrochemical near field microscopy (scanning probe microscopy) are shown in Bottomley (Anal. Chem. 70 (1998), 425R-475R) and in Wiesendanger (Scanning Probe Microscopy and Spectroscopy (Methods and Application) (Ed. R. Wiesendanger), Cambridge Press (1994)), which are incorporated herein by reference. It should be noted that not only is the topography of the surface of the substrate mapped, but also an exact distance to the sample surface in the near field region for the electroactive area is provided using bifunctional AFM-SECM scanning probe tips. In addition, the AFM system 120 can control the height of the AFM-AC-SECM device 100 relative to the surface of the substrate. The AFM system 120, by which surfaces and atoms and molecules present thereon can be visualized with a resolution in the sub-nanometer range, is based on the fundamental work carried out by Binning et al. (Phys. Rev. Lett. 56 (1986), 930-933), also described in EP 0 027 517 A and in U.S. Pat. No. 6,894,272, each of which is incorporated herein by reference.

The AFM-AC-SECM device 100 is moved at a constant or substantially constant distance (also referred to as height) from the surface of the substrate. The AFM-AC-SECM device 100 detects topographical data and electrochemical data, as the AFM-AC-SECM device 100 moves across the surface of the substrate. The data is sent to the data system 140, where the data system 140 is configured to analyze the data for generating an appropriate topographical and electrochemical/impedance representation of the surface of the sample. The obtained data are, in principle, a change of the resistance within the small gap between electrode and sample surface. The resistance is dependent, at least in part, on the nature of the sample (e.g., whether the electrical field lines can bypass the high resistance by going through the sample in case of a conductive sample). In addition, the data system 140 acts as a feed back loop for the AFM system 120 to adjust the distance of the AFM-AC-SECM device 100 from the surface of the substrate to keep the distance constant or substantially constant.

Embodiments of the present disclosure provide for AFM-AC-SECM devices and AFM-AC-SECM systems that can simultaneously and independently carry out an electrochemical and a topographical near field microscopy. As described above, embodiments of the present disclosure include a region for topographical near field measurement and a region for electrochemical near field measurement. The region for the topographical near field measurement extending completely as far as to the immediate tip (AFM tip) of the AFM-AC-SECM device (the probe for topographical near field measurement). The region for near field measurement starts at a defined distance from the immediate tip. The region for topographic near field measurement is covered by a conductive material except for the immediate tip. The conductive material is covered by an insulating material, except for the region for the electrochemical near field measurement.

Embodiments of the present disclosure can simultaneously and independently perform a measurement of both, the topology, and also of the electrochemical properties in the near field of the surface of the substrate, while the substrate and the AFM tip of the AFM-AC-SECM device are in a redox-mediator free solution. The topology is determined in a manner via the immediate tip using topographical near field microscopy such as e.g., atomic force microscopy. Using this information, the height of the AFM-AC-SECM device, and thus of the integrated electroactive area, is simultaneously adjusted relative to the surface of the substrate such that it is located at a constant distance from the surface. Simultaneously, the electrochemical properties of the surface are determined by the region for electrochemical near field measurement in a redox-mediator free solution. Thus, the electrochemical or chemical information can be independently obtained and completely de-coupled from the topographical information. In this regard, non-falsified electrochemical or chemical measurement signal can be quantitatively detected in a redox-mediator free solution. In particular, embodiments of the present disclosure can examine or detect local, physical, and/or chemical interaction at the sample surface, or between the surface of the substrate and the sample and the AFM-AC-SECM device in the near field. In this manner, a quantitative evaluation of the measured data is obtained according to embodiments of the present disclosure.

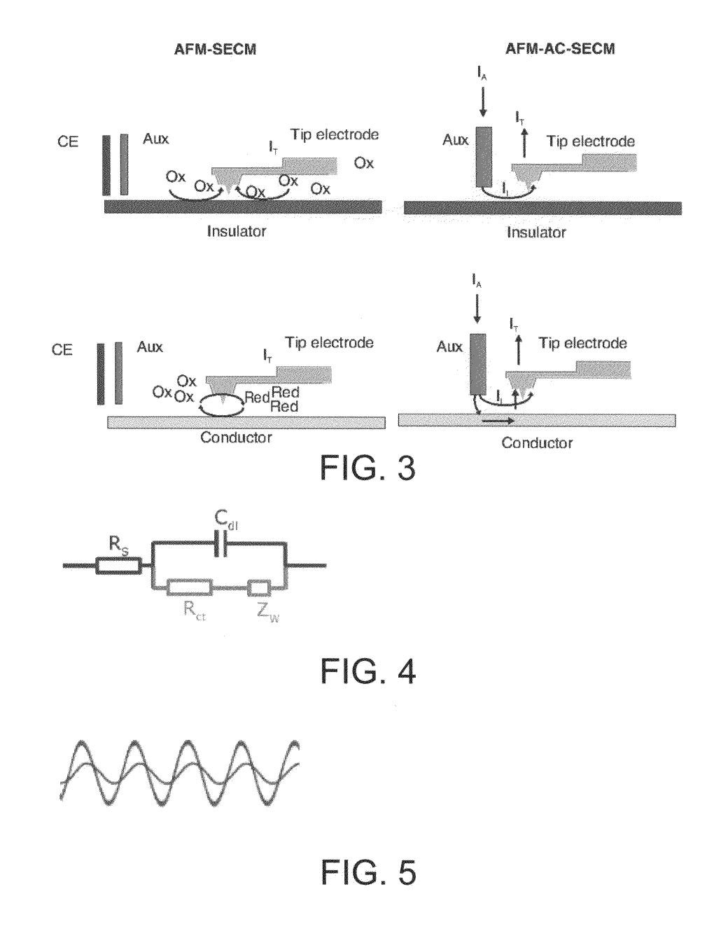

In contrast to embodiments of the present disclosure, scanning electrochemical microscopy is an in-situ scanning probe technique, which allows mapping of (electro)activity changes at the sample surface based on monitoring of local changes of Faraday processes recorded at a miniaturized probe electrode. Signal generation provides laterally resolved electrochemical imaging based on changes in the flux of the converted molecular species and, hence, its local concentration. For locally mapping changes of flux or concentration pertinent to the electroactive species, the electrochemical probe is positioned at a defined distance close to the sample surface. Diffusion of a redox mediator towards the electroactive area is affected by the sample morphology, the interfacial reactions at the sample surface, the distance d between the ultramicroelectrode (UME) and the sample surface, and by the geometry of the UME and its insulating shielding, if the probe is in close proximity to the sample surface. In a combined AFM-SECM probe, the electrode is integrated recessed from the AFM tip, thereby utilizing the AFM tip as a spacer for the electrode, which is thereby kept at a constant distance to the sample surface (FIG. 3 left).

FIG. 3 (left top and bottom) illustrates a signal generation process in a conventional SECM experiment with a redox mediator in solution reduced at the AFM tip-integrated working electrode, thereby generating a Faradaic redox current measured in a three-electrode configuration using a reference electrode (CE) and an auxiliary electrode (Aux).

FIG. 3 (right top and bottom) illustrates an embodiment of the present disclosure for a signal generation process in an AFM-AC-SECM experiment without a redox mediator in solution measuring frequency-dependent impedance changes of an AC current generated by the superposition of a sinusoidal AC voltage onto the DC potential applied to the working electrode.

For many applications of imaging electrochemistry (e.g., corrosion studies, which are inherently based on redox processes) the addition of a redox species to the solution for providing contrast in a conventional SECM experiment is problematic, since this may change the sample or the observed processes by causing additional unwanted reactions at the sample surface leading to misinterpretation. Consequently, analytical techniques probing corrosion processes ideally observe chemical changes without contributing to the analytical signal. In general, impedance imaging is a contrast mechanism that can be used for visualizing a wide variety of surface features. Embodiments of the present disclosure provide simultaneous topographical and electrochemical information, where such information can be complementary to the obtained surface topography.

Alternating current (AC) measurements are an attractive alternative to conventional SECM experiments for localized electrochemical measurements in a redox mediator-free solution. In this regard, embodiments of the present disclosure conduct measurements in an electrolyte solution with usually medium to low salt concentration, and by applying an alternating potential between working (the region for electrochemical near field measurement) and reference electrode (FIG. 3, right). This measurement concept can be visualized by an equivalent electronic circuit for AC measurements, as shown in FIG. 4. Since no Faradaic processes are involved (i.e., no redox reaction occurring at the sample surface), the circuit is reduced to a serial connection of the solution resistance (R_{S}) and the capacitance (C_{d}), whereas the charge transfer resistance (R_{CT}) and the Warburg impedance (Z_{W}) are omitted.

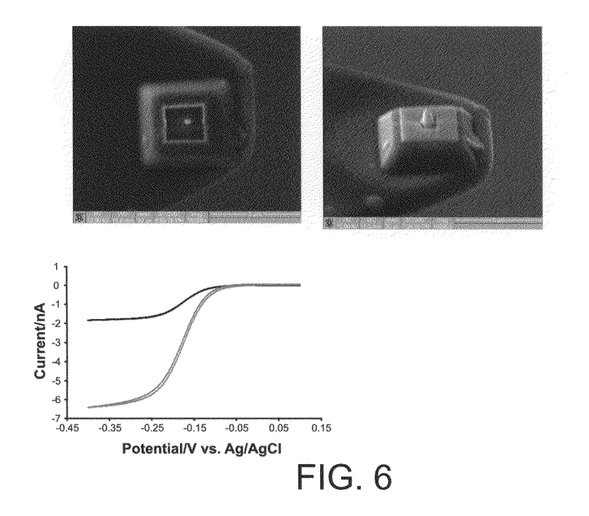

The resulting alternating signal is inversely proportional to the solution resistance at high frequencies. In order to perform an AC-SECM measurement, the measurement setup additionally needs to include a lock-in oscillator generating a sinusoidal AC potential, which is superimposed onto the DC potential applied between the reference electrode and the probe electrode, and which results in an AC current with an according amplitude and phase shift, as shown in FIG. 5 and described in more detail herein.

The time constant of the electrochemical cell for AC measurements (no additional electroactive species added to the solution) is dependent on the electrode radius, the electrolyte concentration, the distance between electrode and sample, and the nature of the sample. Low agitation frequencies result in high capacitive contributions to the total cell resistance, and hence, to a reduced impact of the solution resistance, which is the signal providing parameter. Hence, to obtain a sufficient contrast for imaging the solution resistance should mainly determine the total resistance of the electrochemical cell. Consequently, AC-SECM experiments described in literature so far have been obtained with microelectrodes with electrode radii of a couple of micrometers. However, the effect of further reducing the active electrode size can be compensated by further reducing the electrolyte concentration, or by increasing the agitation frequency. Alternatively, in another embodiment, the electroactive area can be increased by ion beam induced deposition (IBID) using focused ion beam technology, which allows to increase the active surface area of the electrode, while keeping the geometric dimensions of the outer frame length of the electrode basically unaltered. An SEM image of an integrated IBID electrode is shown in FIG. 6 along with the obtained cyclic voltammograms before and after deposition.

While embodiments of the present disclosure are described in connection with Examples 1 and 2 and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLES

### Example 1

### Introduction

AFM-SECM measurements using alternating current mode SECM (AC-SECM) were performed at an AFM tip with an integrated recessed ring microelectrode. Measurements were carried out in a three-electrode arrangement at 14.92 kHz and 110 mVₚₚ in 1 mM KCl solution. Combined AFM-AC-SECM enables the detection of electrochemical surface properties with high lateral resolution without addition of a redox mediator, thereby providing images on topographical changes along with chemical information. For demonstrating the capabilities of this method, simultaneously recorded data on the topography and the surface conductivity of gold/glass structures and of microelectrode arrays are discussed.

### Experimental

A combined AFM-SECM probe with an integrated ring electrode (outer radius b=2.5 μm; inner radius a=2.0 μm; ratio a/b=0.80) was used. The electrode was recessed by 1.05 μm from the apex of the AFM tip, simultaneously defining the length of the actual AFM probe. The tip fabrication process has been described in detail elsewhere (ASME (2005) 79424; Micro-Electro-Mechanical Systems 2005, 7, 383-387; Surf. Interf. Anal. 33 (2002) 146; Analytical Chemistry 79 (13) 4769-4777 (2007), each of which is incorporated herein by reference). The electrochemical cell comprises an inert platinum counter electrode, a silver/silver chloride pseudo reference electrode (AgQRE), and the AFM tip-integrated electrode as the working electrode (WE). All measurements were performed in 1 mM KCl solution.

### Results and Discussion

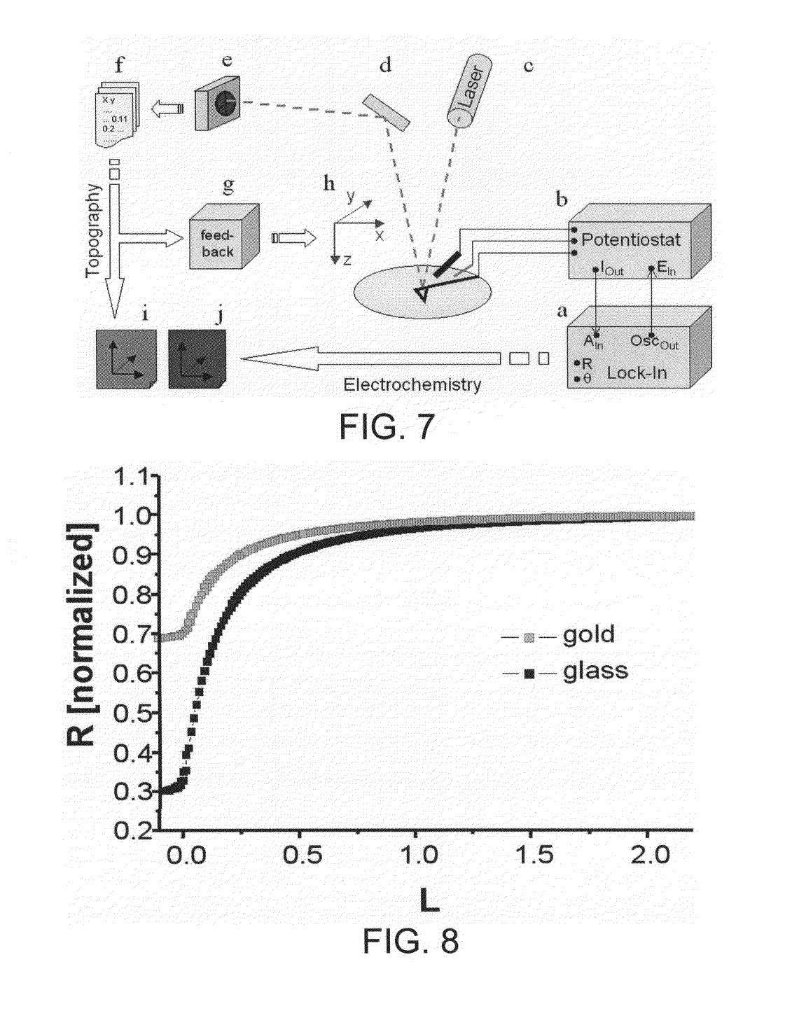

In AC-SECM experiments, the applied potential at the WE—here, the ring microelectrode integrated at the AFM-SECM probe—is an alternating voltage generated via a lock-in amplifier (PAR 5210, Perkin Elmer, Bad Wildbad, Germany), which is superimposed as a sinusoidal wave onto a fixed potential provided via a potentiostat (PG 100, Jaissle Elektronik, Waiblingen, Germany) (Electrochem. Commun. 4 (2002) 134, which is incorporated herein by reference). The alternating current response resulting from the AC-potential is routed back into the lock-in amplifier (FIG. 7, a and b). This phase sensitive detection scheme provides localized values of the current magnitude (FIG. 7, j), which are inversely proportional to the local impedance, hence, providing laterally resolved information on the nature of the instantaneous sample surface. In electrochemical systems of low conductivity with the solution resistance dominating the overall impedance, it has been shown that the current magnitude R and the phase shift φ are strongly dependent on the tip-to-sample distance, as well as on the chemical nature of the sample in the near field regime (Electrochem. Commun. 4 (2002) 134; Electrochim. Acta 48 (2003) 1115, each of which is incorporated herein by reference). However, a comprehensive theoretical description of the observed phenomena in the near-field regime has not yet been developed.

The commonly accepted explanation describes an increase of impedance as the tip approaches an insulating substrate, since the layer of electrolyte for the current to pass through decreases. As the impedance increases with smaller tip-to-sample distances, the magnitude R of the alternating current response decreases. However, this decrease in impedance is less pronounced when the tip electrode is in close vicinity to a conducting surface, since the current field lines are partially directed through the metal (J. Solid State Electrochem. 8 (2004) 683, which is incorporated herein by reference). In FIG. 8, the magnitude R of the current response is shown as a function of the tip-to-sample separation in a conventional AC-SECM experiment, as a platinum disk ultramicroelectrode with an electrode diameter of 7 μm embedded in an insulating glass capillary approaches a gold surface (FIG. 8, gray curve), and an insulating glass surface (FIG. 8, black curve), respectively. Evidently, the current response decreases with decreased distance of the electrode to the sample surface. For the conductive gold surface, with decreasing distance the drop in current is clearly less pronounced, as compared to the insulating glass surface. Applying these principles to the presented combined AFM-AC-SECM measurements enables simultaneously mapping the AC current during AFM imaging.

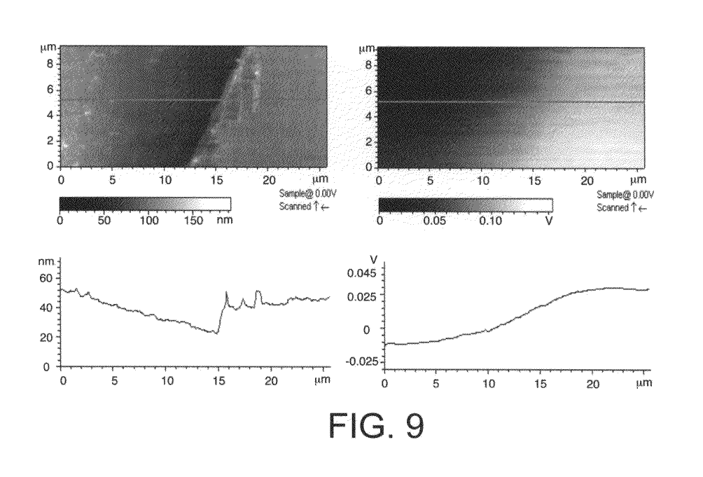

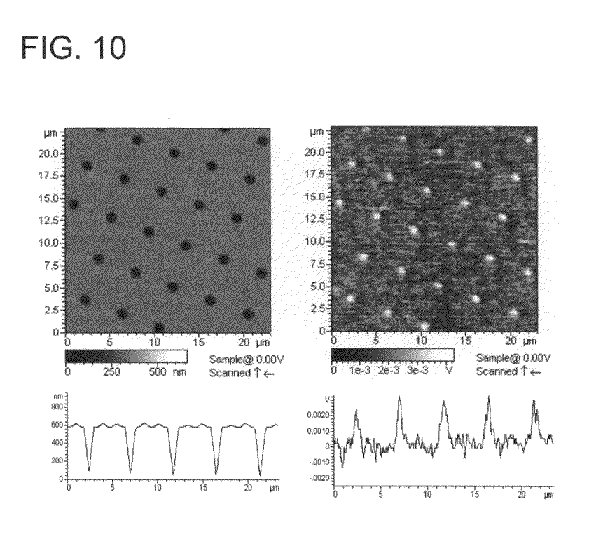

In order to confirm the applicability of combined AFM-AC-SECM measurements, a model sample with periodic gold strips (width: 500 μm; thickness: 100 nm) sputtered onto a glass substrate was investigated providing the required contrast between insulating and conductive features. The contrast in the electrochemical image is dependent on several parameters such as solution conductivity, cell geometry, electroactive area of the tip, size of conductive sample compared to the tip size, and applied frequency. Hence, prior to each experiment a frequency sweep was performed. The frequency providing a maximum value of the current magnitude was selected for further experiments. FIG. 9A shows the topography of the test sample. The simultaneously obtained AC-SECM measurement (FIG. 9B) was recorded at a frequency of 5.01 kHz with an amplitude of 110 mVₚₚ superimposed onto a DC bias of −100 mV applied to the tip-integrated WE. In agreement with the data shown in FIG. 8, scanning the integrated probe across the gold features results in lower overall impedance, which translates into higher current values in contrast to scanning across the insulating glass substrate. In order to demonstrate high-resolution AC-SECM measurements, a periodically micro-patterned silicon nitride/gold layer revealing recessed 1 μm disk-electrodes was investigated. During these measurements, the voltage perturbation was set at a frequency of 14.92 kHz with an amplitude of 110 mVₚₚ superimposed onto the −100 mV DC bias at the tip-integrated WE. FIG. 4A shows the topography of the sample structure. The AC data displayed in FIG. 4B clearly reveals a significant increase in current response above the gold disk-electrodes indicating higher conductivity at these locations. As the gold spots are recessed from the surrounding insulating silicone nitride layer, the increased current response readily coincides with the simultaneously recorded topographic image.

### Conclusion

Identifying such conductive hotspots at passivated surfaces is especially valuable in corrosion research. Hence, the combined AFM-AC-SECM device presented in this study provides the technology for mapping electrochemical surface properties in solution without artificially adding a redox mediator with a lateral resolution that has not been reported to date. Furthermore, direct localized correlation to topographical features and their changes is inherently provided by combined AFM-AC-SECM, as the sample topography and electrochemical surface properties are simultaneously obtained.

This example describes the combination of AFM imaging with spatially resolved impedance mapping via AC-SECM utilizing AFM tips with integrated recessed electrodes. Furthermore, embodiments of the present disclosure can use the AFM-AC-SECM technique for high-resolution investigations of pitting corrosion processes, and similar localized events.

### Example 2

### Introduction

Alternating current mode scanning electrochemical microscopy (AC-SECM) enables local detection of electrochemical surface activity without any redox mediator present in solution. Z-approach curves towards the substrate result in a negative feedback curve of the AC signal for insulating samples. On conducting samples, however, the shape of the feedback curve was found to be dependent on the AC perturbation frequency. Approach curves over a wide range of frequencies were performed and the results were applied to interpret laterally resolved frequency dependent measurements obtained with combined AFM-AC-SECM. This frequency dependence of the signal was utilized to fine-tune the electrochemical contrast in lateral imaging in AC-SECM. An array of gold microelectrodes embedded in silicon nitride displaying significant changes in electrochemical activity as well as in topography was investigated using a bifunctional AFM-SECM tip with an integrated recessed ring microelectrode. Due to the unique geometrical conditions the electrochemical contrast between the conducting gold spots and the insulating SiₓN_{y} areas is reversed, crosses zero, and inverts as function of the applied AC frequency.

### Experimental

### Approach Curves in AC-SECM:

A three-electrode arrangement was used consisting of an ultramicroelectrode, a large ring shaped Pt-counter electrode, and a miniaturized double-junction reference electrode. The inner compartment of the reference electrode was filled with 1 M KCl, while the outer compartment contained 50 mM KCl to reduce the osmotic pressure at both junctions, and to avoid leakage of ions into the solution of 1 mM KCl inside the electrochemical cell. Microelectrodes were prepared following a protocol described in detail before (W. Adv. Mater. 1995, 7(6), 568-571, which is incorporated herein by reference). The potential applied by a potentiostat (PG 100, Jaissle Elektronik GmbH, Waiblingen, Germany) was superimposed by a sine wave specified at a lock-in amplifier (5210 Signal Recovery, Oak Ridge, USA). The resulting alternating current response was fed back from the potentiostat into the signal channel of the lock-in amplifier. The phase sensitive detection scheme delivers the magnitude of the current as an analog signal that is recorded via a PC as a function of the tip position. An AD-card (CIO-DAS-1602/16, Plug-In, Eichenau, Germany) and an x-y-z-stepper motor positioning stage (OWIS, Staufen, Germany) are used.

### Combined AFM/AC-SECM:

Details on the combined set-up for AC-AFM-SECM measurements have been described earlier (Electrochem. Communications 2007, 9, 1311-1315; Electrochem. Commun, 9, 1311-1315, 2007; Anal. Chem., 79, 5435-5438, 2007, each of which is incorporated herein by reference). A silver/silver chloride wire serves as pseudo reference electrode (AgQRE), and a Pt-wire as counter electrode. The fabrication process of the AFM tip with integrated electrode has been described in detail elsewhere (Surf. Interface Anal. 2002, 33(2), 146-150; Micro-Electro-Mechanical Systems 2005, 7, 383-387; Analytical Chemistry 79 (13) 4769-4777 (2007), each of which is incorporated herein by reference). The tip-integrated ring microelectrode used in all measurements presented within this contribution had an inner radius b of 1.25 μm and an outer radius a of 1.35 μm (ratio a/b=0.80). The electrode was recessed 1.05 μm from the apex of the SiC AFM tip.

### Results and Discussion

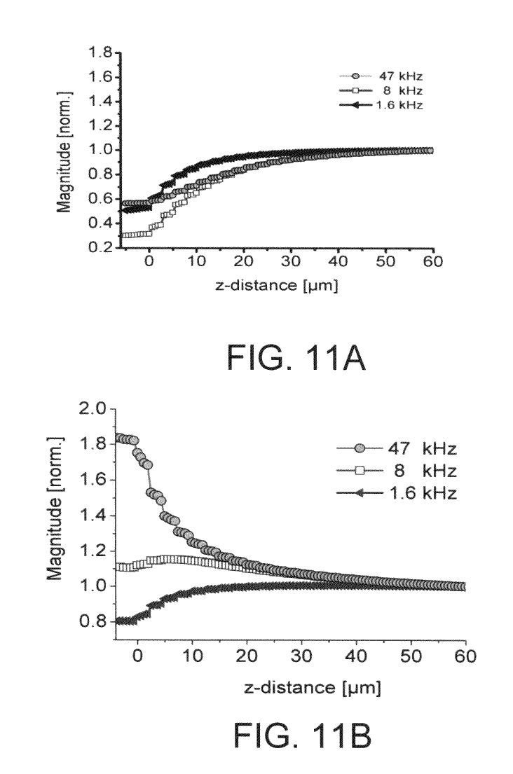

AC-SECM visualizes conducting and non-conducting features at the sample surface. This ability originates in a change in current distribution when the UME is placed in close proximity to a conducting site at the surface, which the current can pass through. Thereby, it bypasses the high impedance region between tip and substrate leading to an increase in current magnitude at the tip. Since the signal is an alternating current, no charge transfer is involved and the electric field lines pass through the conductor in order to shortcut the way to the counter electrode. This possibility of an alternative pathway for the electrical field lines of lower impedance is the reason that the obtained current signal at conducting areas of the sample surface is always higher than over insulating material. Despite this fact, there are significant differences in the approach curves towards a conductive surface depending on the applied AC frequency. Approach curves towards insulating surfaces invariably result in a negative feedback response as shown for three exemplary frequencies in FIG. 11A. Towards conducting surfaces, however, the shape of the approach curve can vary from negative (Anal. Chem. 2001, 73(20), 4873-4881, which is incorporated herein by reference) response, which is always less negative than over an insulator (W. Electrochem. Commun. 2004, 6(3), 288-293; J. Solid State Electrochem. 2004, 8(10), 683-692; J. Phys. Chem. B 2006, 110(13), 6776-6784) to positive feedback response (Electrochem. Commun. 2002, 4(2), 134-138; Anal. Chem. 1993, 65(24), 3605-3614; J. Phys. Chem. B 2004, 108(31), 11620-11626; J. Solid State Electrochem. 2004, 8(10), 683-692; J. Phys. Chem. B 2006, 110(13), 6776-6784, each of which is incorporated herein by reference). Approach curves demonstrating this behavior of the AC current magnitude are shown in FIG. 11B. For the given circumstances a perturbation frequency of 1.6 kHz led to a negative feedback response, while 47 kHz resulted in positive feedback. The point of zero-crossing was observed at about 8 kHz. Hence, by tuning the frequency this increase in relative change of the signal can be used to obtain a significantly improved contrast in imaging of the electroactive properties at the sample surface.

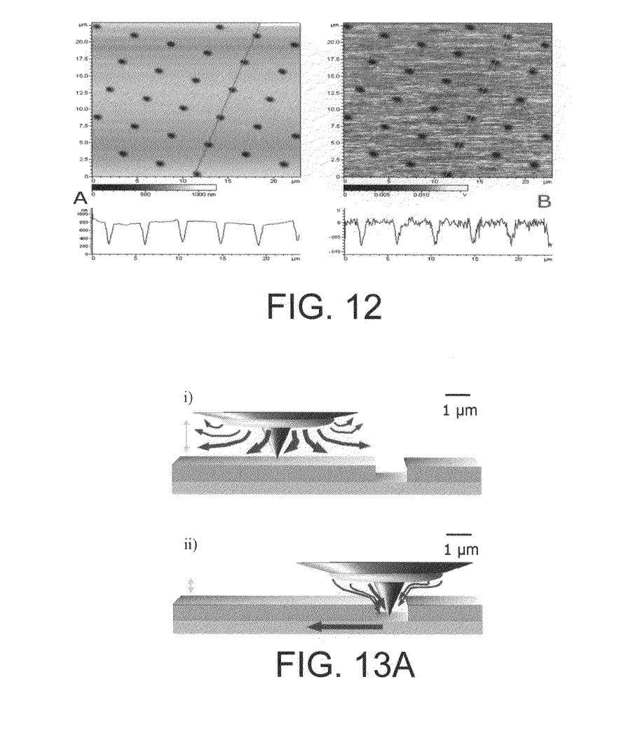

While the frequency dependency of the approaches curves was described previously (J. Phys. Chem. B 2006, 110(13), 6776-6784, which is incorporated herein by reference) no lateral imaging had been demonstrated as a function of frequency with this configuration. The influence of the frequency on the imaging contrast was investigated using combined AFM-SECM at a model sample. A periodic array of recessed gold microelectrodes of 1 μm diameter, fabricated from a gold-coated silicon wafer with a microstructured silicon nitride film (periodicity: 4 μm) was scanned in contact mode AFM-AC-SECM with a tip-integrated Pt-ring electrode. FIG. 12 shows the simultaneously obtained topographical and AC-image of a 25 μm×25 μm scan recorded at a frequency of 5.01 kHz. The topographic AFM image (left) clearly shows the pore array with the expected periodicity of 4 μm. The length of the thorn of the combined AFM-SECM tip defines the small gap between micro ring electrode and substrate. Hence, a thin gap filled with electrolyte is created where the current has to pass through leading to increased impedance between working (tip) and counter electrode. Since the recessed underlying gold substrate is large, the high impedance of the thin film electrolyte can be avoided by electric field lines taking a path into the gold layer, traveling laterally with almost no impedance, and leaving the conducting substrate at a remote place closer to the counter electrode. The recessed gold microspots are interconnected offering a shortcut for the AC current. Hence, the current magnitude at these sites is expected to increase. However, the AC-SECM image in FIG. 12 indicates a decreased value in current magnitude above the gold spots in comparison to the value obtained over silicon nitride.

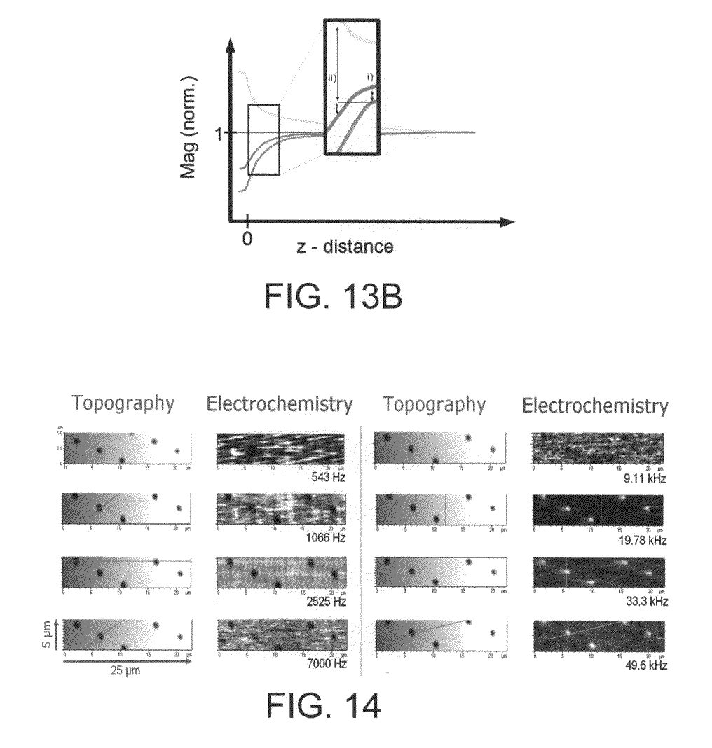

This result can be explained by the geometric particularities of the probe and surface structure. AFM-SECM is a combined technique providing superior topographic resolution leading to a constant distance between the integrated electrode and a flat sample surface. However, if topological surface features are comparable in size to the length of the thorn of the AFM tip, a change in electrode-to-sample distance has to be taken into account. The sketch to scale shown in FIG. 13A i) illustrates the investigated model sample in relation to the tip-integrated electrode. The recessed ring electrode (diameter 2.7 μm) has about 2.7 times of the diameter of the recessed gold spot. When the AFM thorn travels into the pore, this leads to a significant decrease in the ring electrode-to-sample distance (FIG. 13A ii). Therefore, concomitantly the impedance is increased due to the decrease of the electrolyte film thickness.

Independently of the shape of the approach curve the signal of the current magnitude should always increase when the electrode scans from a non-conducting to a conducting part of the sample (FIG. 13B). Interestingly, the expected signal increase can be masked, if a change in distance occurs simultaneously. The electroactive area of the combined AFM-SECM probe is 450 nm (thickness of the insulating layer) closer to the SiₓN_{y} surface when the thorn moves into the pore. The local impedance increases due to the smaller electrolyte film thickness in the gap. This leads to a value of the current magnitude correlated to a point of the approach curve, which is closer to the surface and, hence, results in a smaller signal as long as the chosen frequency causes a negative feedback above the conductor.

Since the slope of the approach curve is dependent on the AC frequency applied (see FIG. 11), the image contrast should change as positive feedback is obtained at sufficiently high frequency. In the case of positive feedback the signal of the current magnitude over a conducting site is higher than over an insulator regardless of any changes in distance. This frequency dependence of the contrast was further investigated in a series of scans with perturbation frequencies ranging from 543 Hz to 49.6 kHz. As can be derived from FIG. 14 there is obviously a threshold frequency where AC-SECM imaging is possible. Perturbation frequencies of 543 Hz and below do not lead to sufficient electrochemical sensitivity. The images recorded at 1066 Hz, 2525 Hz and 7000 Hz are similar to the image shown in FIG. 12 with the scan at 2525 Hz providing the highest electrochemical contrast in the left hand column. The AC-SECM images in the right hand column show the inversion at higher frequencies (19.78 kHz, 33.3 kHz, 49.6 kHz) that is caused by a switch to positive feedback in the approach curves over conductive substrates at higher frequencies as shown in FIG. 11. The expected zero-crossing of the contrast was obtained at 9.11 kHz in the AFM-AC-SECM imaging series. An upper limit of the perturbation frequency was not determined in this set of experiments.

### Conclusion

Visualizing confined conducting spots within an insulating matrix can serve as a simplified model for identifying precursor sites for pitting corrosion. For the first time, the dependence of the lateral electrochemical contrast on the AC-frequency is shown in a sequential series of scans. The presented results suggest that the frequency along with the topography is crucial to avoid misinterpretation of data (see FIG. 14 @ 9.11 kHz), especially above unknown samples. Hence, the determination of the absolute distance of the electrode to sample is essential for AC-SECM studies of unknown samples.

Additional details regarding embodiments of the present disclosure or related to embodiments of the present disclosure may be described in: J. Kor. Phys. Soc., 51, 290-294, 2007; Appl. Phys. Lett., 82, 1592-1594 (2003); Appl. Phys. Lett., 81, 349-351 (2002); American Chemical Society Symposium Volume, 320-336 (2002); and Anal. Chem. 73, 2491-2500 (2001), each of which is incorporated herein by reference.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to 5%” should be interpreted to include not only the explicitly recited concentration of about 0.1 wt % to about 5 wt %, but also include individual concentrations (e.g., 1%, 2%, 3%, and 4%), and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’” includes “about ‘x’ to about ‘y’”.

Although the methodologies of this disclosure have been particularly described in the foregoing disclosure, it is to be understood that such descriptions have been provided for purposes of illustration only, and that other variations both in form and in detail can be made thereupon by those skilled in the art without departing from the spirit and scope of the present invention, which is defined solely by the appended claims.

What is claimed is:

1. A near-field measurement-alternating current-scanning electrochemical microscopy device, comprising:
a region for topographical near field measurement; and
a region for electrochemical near field measurement, wherein the region for the electrochemical near field measurement is in electrical communication with an alternating current (AC) supply system such that the region for the electrochemical near field measurement is configured to receive an AC potential from the AC supply system.

2. The device of claim 1, wherein the near-field measurement-alternating current-scanning electrochemical microscopy device is an atomic force measurement-alternating current-scanning electrochemical microscopy device.

3. The device of claim 2, wherein the AC supply system includes a lock-in oscillator adapted to generate the AC potential, wherein the AC potential is a sinusoidal AC potential, wherein the sinusoidal AC potential is superimposed onto a DC potential applied between a reference electrode and the region for the electrochemical near field measurement.

4. The device of claim 2, wherein the region for the electrochemical near field measurement is an ultramicroelectrode.

5. The device of claim 4, wherein the ultramicroelectrode has an internal radius of about 50 μm to 5 nm and an external radius of about 100 μm to 10 nm.

6. The device of claim 4, wherein the ultramicroelectrode is made of a material selected from: gold, platinum, carbon, copper, palladium, iridium, antimony, (doped) diamond, (doped) diamond-like carbon, composites of each, or composites of each with other materials.

7. The device of claim 2, wherein the device is configured to simultaneously and independently conduct an electrochemical near field measurement and a topographical near field measurement.

8. The device of claim 7, wherein a distance from a surface of a structure is regulated by the topographical near field measurement.

9. The device of claim 7, wherein the electrochemical near field measurement includes the measurement of frequency-dependent impedance changes.

10. The device of claim 2, wherein the region for topographical near field measurement extends completely to an immediate tip of the arrangement, wherein the region for topographical near field measurement is covered by a conductive material except for the immediate tip, wherein the conductive material is covered by an insulating material except for the region for the electrochemical near field measurement, and wherein the region for electrochemical near field measurement starts a defined distance from the immediate tip

11. The device of claim 10, wherein the defined distance is about 5 nanometers to 5 micrometers.

12. The device of claim 2, wherein the region for the electrochemical near field measurement has a shape selected from: a circular shape, a frame-shaped shape, a disk-shaped shape, a polygonal shape, or a combination thereof.

13. The device of claim 1, wherein the near-field measurement-alternating current-scanning electrochemical microscopy device is selected from: a scanning tunneling microscope (STM) measurement-alternating current-scanning electrochemical microscopy device, a scanning electrochemical microscope (SECM) measurement-alternating current-scanning electrochemical microscopy device, a scanning thermal microscope (SThM) measurement-alternating current-scanning electrochemical microscopy device, or a scanning Kelvin probe microscope measurement-alternating current-scanning electrochemical microscopy device.

14. An atomic force measurement-alternating current-scanning electrochemical microscopy system, comprising:
a device including:
a region for topographical near field measurement; and
a region for electrochemical near field measurement, wherein the region for the electrochemical near field measurement is in electrical communication with an alternating current (AC) supply system such that the region for the electrochemical near field measurement is configured to receive an AC potential from the AC supply system, and
a measurement cell including the device and an artificially added electroactive species free solution.

15. The system of claim 14, wherein the AC supply system includes a lock-in oscillator adapted to generate the AC potential, wherein the AC potential is a sinusoidal AC potential, wherein the sinusoidal AC potential is superimposed onto a DC potential applied between a reference electrode and the region for the electrochemical near field measurement.

16. The system of claim 14, wherein the electrochemical near field measurement includes the measurement of frequency-dependent impedance changes.

17. A method for examination of a surface of a substrate, comprising:
providing an atomic force measurement-alternating current-scanning electrochemical microscopy system, comprising:
a device including:
a region adapted for topographical near field measurement; and
a region for electrochemical near field measurement, wherein the region for the electrochemical near field measurement is in electrical communication with an alternating current (AC) supply system such that the region for the electrochemical near field measurement is configured to receive an AC potential from the AC supply system, and
a measurement cell including the device and an artificially added electroactive species free solution;
disposing the device adjacent the surface, wherein the surface is to be examined by the region adapted for topographical near field measurement and the region for electrochemical near field measurement, wherein the region adapted for topographical near field measurement measures a distance to the surface, and wherein the region for electrochemical near field measurement measures frequency-dependent impedance change in the artificially added electroactive species free solution; and
examining the surface by moving the device over the surface.

18. The method of claim 17, further comprising: measuring frequency-dependent impedance changes.

19. The method of claim 18, further comprising: measuring a distance to the surface.
